(19) United States
(12) Patent Application Publication
(10) Pub. No.: US 2005/0000059 A1
(43) Pub. Date: Jan. 6, 2005

(54) Sliding hinge apparatus

(75) Inventors: Baek-Nae Sung, Yangsan-city (KR); Jae-Chan Heo, Busan-city (KR)

Correspondence Address: Rocco S. Barrese, Esq.;DILWORTH & BARRESE, LLP, 333 Earle Ovington Boulevard, Uniondale, NY, 11553, US

(73) Assignee: POSTEC ELECTRONICS CO., LTD., GYUNGSANGNAM-DO (KR)

(21) Appl. No.: 10/653,668

(22) Filed: Sep. 2, 2003

(30) Foreign Application Priority Data
Jul. 2, 2003 (KR) 10-2003-44467

(51) Int. Cl. E05D 11/10

(52) U.S. Cl. 16/320

(57) ABSTRACT

The present invention relates to a sliding hinge apparatus. The sliding hinge apparatus of the present invention comprises a lower plate 31 with permanent magnets attached on a surface thereof and rails formed therein, and an upper plate 32 with permanent magnets attached on a surface thereof opposite to the lower plate 31 and rails having a shape complementary to the rails of the lower plate 31 formed therein, whereby the upper plate is engaged with the lower plate via the rails. According to the present invention, the sliding hinge apparatus that is very thin and is capable of semi-permanently maintaining its quick and smooth operation can be obtained.

### BACKGROUND OF THE INVENTION

1. Field of Invention

The present invention relates to a sliding hinge apparatus, and more particularly, to a sliding hinge apparatus wherein a quick and smooth operation thereof can be maintained semi-permanently and an entire thickness thereof is thin.

2. Description of the Prior Art

As the electronics industry has rapidly advanced, a variety of telecommunication or mobile communication equipment such as a mobile phone or PDA (personal digital assistance) has been recently developed and their importance in the daily life has gradually grown.

The equipment such as the mobile phone is roughly divided into two parts, i.e. a display unit including a LCD (liquid crystal display) and a main body including a keyboard. A hinge apparatus is then interposed for between the two parts for their interconnection.

Such a hinge apparatus is classified into two kinds, i.e. a related art folding hinge apparatus and a sliding hinge apparatus. The related art folding hinge apparatus is configured such that the display unit is pivoted on a specific point on an upper end of the main body to be folded onto or unfolded from the main body, and the sliding hinge apparatus is configured such that the display unit is slid, i.e. linearly reciprocates, on the main body to be folded onto or unfolded from the main body.

The present invention is directed to the latter of two kinds of hinge apparatuses, i.e. the sliding hinge apparatus. By way of example, a slide-type mobile phone to which the sliding hinge apparatus is typically applied will be hereinafter described.

As shown in FIGS. 1a and 1b, the related art mobile phone 10 comprises a display unit 12 including a LCD L and a main body 11 including a numeric pad N and a battery B.

FIG 1b is a view illustrating that the mobile phone employs the sliding hinge apparatus. That is, in this figure is shown a state where the display unit 12 has been slid upwardly on the main body 11, i.e. a slide-up state.

FIGS. 2a and 2b show a related art sliding hinge apparatus capable of connecting the display unit and the main body of the slide-type mobile phone and maintaining a relative reciprocating linear motion between the display unit and the main body, i.e. a sliding state. Referring to these figures, the sliding hinge apparatus 20 comprises a lower plate 21 which is integrally formed with the main body of the mobile phone, an upper plate 22 which is coupled with the display unit to lineally move together with the display unit, and a torsion spring 23 which is interposed between the two plates 21 and 22 for their interconnection.

One end of the torsion spring 23 is inserted into a hole P1 formed in the lower plate 21, whereas the other end thereof is wound around a protrusion P2 formed on the upper plate 22. Therefore, as the upper plate 22 slides on the lower plate 21, the torsion spring 23 is repeatedly expanded and contracted between the aperture P1 and the protrusion P2 to which both ends of the spring are fixed.

That is, as the upper plate 22 integrally formed with the display unit is pushed upward from a slide-down state shown in FIG. 2a to a slide-up state shown in FIG. 2b, gradually increasing torsional load is applied to a pair of torsion springs 23 disposed at both sides of the plate. After the upper plate 22 passes through a certain intermediate point, the torsional load is then gradually decreased. Finally, the torsional springs are in the almost same state as the slide-down state.

The upper plate 22 coupled with the display unit of the mobile phone becomes in a mechanical equilibrium at the uppermost end of FIG. 2a and the lowermost end of FIG. 2b. Therefore, the upper plate 22 cannot be further moved even though any additional stopper is not provided.

The additional stoppers are not required in the kinematical and mechanical aspects of the hinge apparatus 20 itself. In consideration of the safety of the whole mobile phone, however, a stopper for limiting a relative motion of the display unit with respect to the main body is generally provided at the interconnection between the main body and the display unit.

FIG. 3 is a sectional view taken along line C-C shown in FIG. 2a. Referring to the figure, rails are formed between the lower and upper plates 21 and 22 of the sliding hinge apparatus 20 so as to perform the relative motion between the plates.

That is, as shown in FIG. 3, rectangular grooves are formed on surface of both ends of the lower plate 21, whereas rectangular protrusions are formed on corresponding portions of the upper plate 22. Therefore, while the upper plate 22 is slid on the lower plate 22, the upper plate 22 moves up and down along the lower plate 23 in a state where the rectangular protrusions of the upper plate 22 are received in the complementary grooves of the lower plate 21.

In general, the rectangular grooves and protrusions are formed to take their own specific shapes upon extrusion of the material for the main body and display unit without need to perform additional processing.

Further, the lower and upper plates 21 and 22 are formed with threaded holes for their respective interconnection with the display unit and the main body, as described above. However, for the sake of easy understanding, the holes were not illustrated in the accompanying drawings.

Furthermore, the related art sliding hinge apparatus has a problem due to a material property of the torsion spring 23 positioned between the lower and upper plates 21 and 22.

That is, when the display unit is slid on the main body, the torsional load is repeatedly applied to and released from the torsion spring 23. In such a case, a stress in the torsion spring 23 produced after the slide-up and slide-down motions are repeated to a certain extent exceeds a fatigue limit of the torsion spring 23, and thus, the spring 23 loses their own inherent elasticity. Consequently, a quick and smooth operation due to the elasticity of the torsion spring 23 is remarkably deteriorated when the display unit including the LCD is slid on the main body.

The stiffness of the torsion spring 23 can be improved by increasing the wire diameter and the number of windings of the torsion spring 23. In such a case, however, there is another problem in that an adverse effect or unreasonable matter related to the increase of equipment size occurs.

### SUMMARY OF THE INVENTION

The present invention is conceived to solve the aforementioned problems in the prior art. Accordingly, an object of the present invention is to provide a sliding hinge apparatus wherein a quick and smooth operation thereof can be maintained semi-permanently and an entire thickness thereof is thin.

According to an aspect of the present invention for achieving the object, there is provided a sliding hinge apparatus wherein permanent magnets are attached to a lower plate engaged with a main body of communication equipment such as a mobile phone or PDA and to an upper plate engaged with a display unit of the equipment including the LCD.

That is, the sliding hinge apparatus of the present invention comprises a lower plate with permanent magnets attached on a surface thereof and rails formed therein, and an upper plate with permanent magnets attached to a surface thereof opposite to the lower plate and rails having a shape complementary to the rails of the lower plate formed therein, whereby the upper plate is engaged with the lower plate via the rails.

### BRIEF DESCRIPTION OF THE DRAWINGS

The above and other objects, features and advantages of the present invention will become apparent from the following description of a preferred embodiment given in conjunction with the accompanying drawings, in which:

FIG. 1a is a front view of a general mobile phone;

FIG. 1b is a right side view showing a slide-up state of a slide-type mobile phone;

FIG. 2a is a front view showing a slide-down state of a related art sliding hinge apparatus;

FIG. 2b is a front view showing a slide-up state of the sliding hinge apparatus shown in FIG. 2a;

FIG. 3 is a sectional view taken along line C-C in FIG. 2a;

FIG. 4a is a front view showing a slide-down state of a sliding hinge apparatus according to an embodiment of the present invention;

FIG. 4b is a front view showing a slide-up state of the sliding hinge apparatus shown in FIG. 4a; and

FIG. 5 is a left side sectional view of the sliding hinge apparatus shown in FIG. 4a.

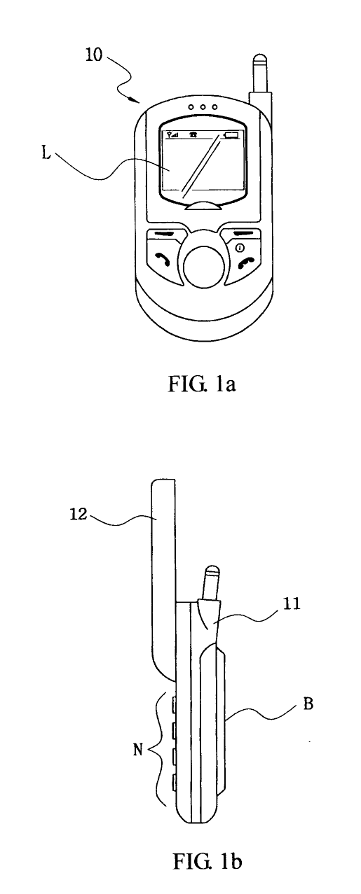

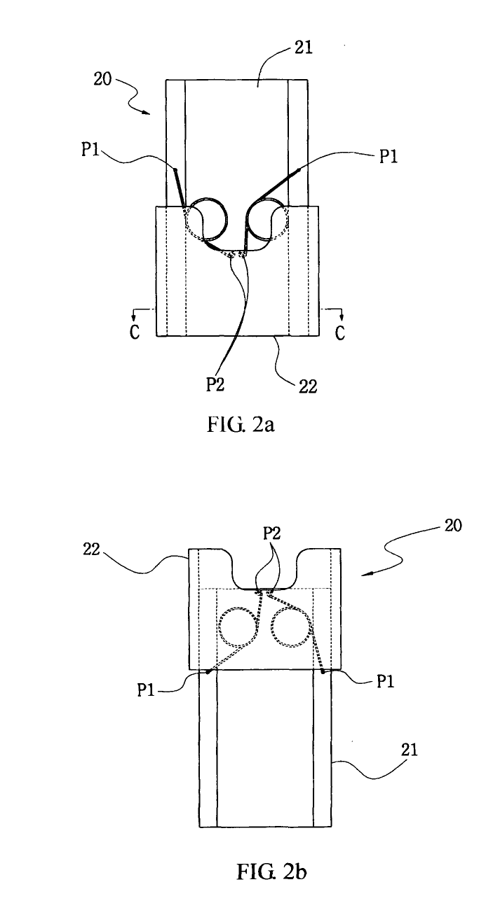

### DETAILED DESCRIPTION OF THE PREFERRED EMBODIMENTS

Hereinafter, a preferred embodiment of a sliding hinge apparatus according to the present invention will be described in detail with reference to the accompanying drawings.

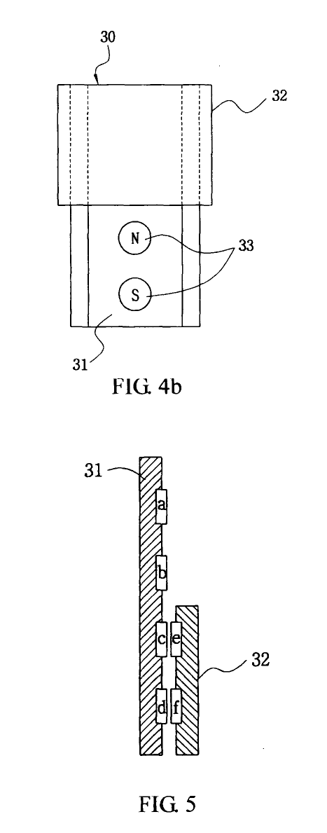

FIGS. 4a and 4b show a slide-down state and a slide-up state of the sliding hinge apparatus, respectively. Referring to these figures, the sliding hinge apparatus 30 comprises a lower plate 31, an upper plate 32 and a plurality of permanent magnets 33.

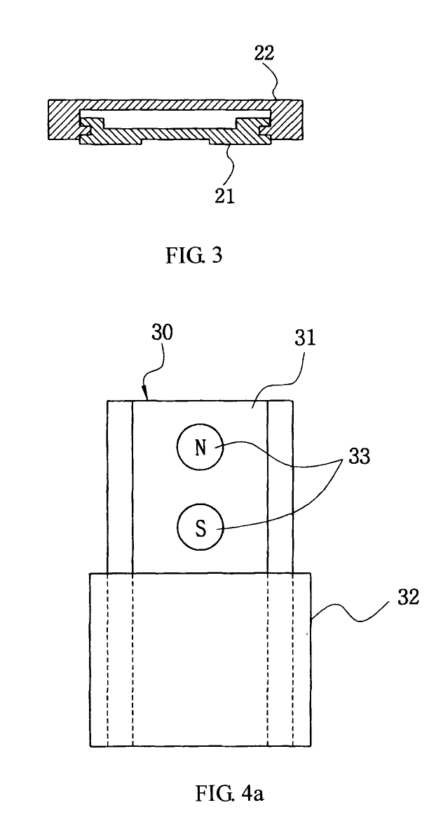

As shown in FIG. 3, an interconnection structure between the lower and upper plates 31 and 32 can be configured in such a manner that rails with rectangular grooves are formed on one of the lower and upper plates 31 and 32 and complementary rails with rectangular protrusions are formed on corresponding portions of the other plate.

However, the interconnection structure between the lower and upper plates 31 and 32 is not necessarily limited to the rail structure including the rectangular grooves and protrusions, so long as the upper plate 32 can be smoothly slid on the lower plate 31.

A mark “N” or “S” on each of the permanent magnets 33 indicates a polarity of a shown surface of the relevant permanent magnet. As shown in FIGS. 4a and 4b, the permanent magnets with different polarities are alternately disposed.

It is preferred that the permanent magnets 33 take the shape of a plate with an appropriate thickness. However, the shape of the permanent magnet is not necessarily limited to a circular plate as shown. Further, it is not necessary to arrange the permanent magnets in a single row. That is, the permanent magnets may be arranged in two rows.

FIG. 5 is a left side sectional view of the sliding hinge apparatus shown in FIGS. 4a and 4b. Referring to this figure, in order to fasten the permanent magnets 33 to the lower and upper plates 31 and 32, recesses corresponding to the permanent magnets a, b, c, d, e and f are first formed on surfaces of the lower and upper plates 31 and 32. Then, the permanent magnets are fitted into the recesses, respectively. At this time, an adhesive may be used selectively according to the circumstances.

As shown in FIG. 4b, the permanent magnets e and f are further attached to the upper plate 32 at the same interval as the permanent magnets a, b, c and d on the lower plate 31.

A state where the poles are arranged will be described with reference to FIG. 5 showing the slide-down state of the sliding hinge apparatus. In such a state, exposed ends of the permanent magnets c and d on the lower plate 31 have “N” polarity and “S” polarity, respectively, whereas exposed ends of the permanent magnets e and f on the upper plate 31 have “S” polarity and “N” polarity, respectively.

That is, in the slide-down state where the upper plate 32 is not slid on the lower plate 31 but maintained in a stationary state, the stationary state is stably maintained due to attraction between the pairs of opposite permanent magnets c-e and d-f of which polarities are different from each other.

On the other hand, in a upwardly sliding process of sliding the upper plate 32 upwardly on the lower plate 31, repulsion between the pairs of opposite permanent magnets b-e and c-f of which polarities are the same as each other is applied until the permanent magnet e on the upper plate 32 reaches the permanent magnet b on the lower plate 31. However, after the permanent magnet e on the upper plate 32 has passed through the permanent magnet b on the lower plate 31, the upper plate 32 is further slid upward to an uppermost position thereof due to attraction between the pairs of opposite permanent magnets a-e and b-f of which polarities are different from each other.

It is apparent that a process of returning the upper plate 32 to an initial stationary state shown in FIG. 4a is performed in reverse to the sequence of the slide-up operation described above.

Meanwhile, it has been described in this embodiment that a plurality of plate-shaped permanent magnets a, b, c, d and e, f are attached to the upper and lower plates 31 and 32 of the sliding hinge apparatus 30, respectively. However, instead of attaching four permanent magnets a, b, c and d separately on the lower plate 31, a single permanent magnet assembly (not shown) on which four unit magnets corresponding to the permanent magnets a, b, c and d are formed at a regular interval may be attached on the lower plate 31. Furthermore, another permanent magnet assembly (not shown) including two unit magnets corresponding to the permanent magnets e and f may also be attached on the upper plate 32. Therefore, the object of the invention can be achieved by using the structure so constructed.

That is, it should be understood that the structure in which sets of the permanent magnets a and b, c and d, e and f are formed on the respective single magnet assemblies as well as the structure in which the permanent magnets a, b, c and d on the lower plate 31 and the permanent magnets e and f on the upper plate 32 are formed on the respective single magnet assemblies can fall within a technical scope of the present invention.

As described above, the sliding hinge apparatus of the present invention is configured in such a manner that the permanent magnets are attached to the lower plate engaged with the main body of the communication equipment such as the mobile phone or PDA and to the upper plate engaged with the display unit of the equipment including the LCD. Therefore, the problems such as the fatigue limit generated in the torsion spring and the deterioration of quick and smooth operation related thereto are basically solved. Accordingly, the slide hinge apparatus in which a quick and smooth operation can be semi-permanently maintained and of which thickness is very thin can be obtained.

Moreover, since the field to which the present invention is applicable is not limited to the communication equipment such as the mobile phone or PDA, the sliding hinge apparatus of the present invention can be widely applied to the electronic equipment comprising the display unit with the LCD and a main body engaged with the display unit.

Although the present invention has been described in connection with the preferred embodiment thereof shown in the accompanying drawings, it is a mere example of the present invention. It can also be understood by those skilled in the art that various changes and modifications thereof can be made thereto without departing from the scope and spirit of the present invention defined by the claims. Therefore, the true scope of the present invention should be defined by the technical spirit of the appended claims.

1. A sliding hinge apparatus, comprising:
a lower plate with permanent magnets attached on a surface thereof and having rails formed therein; and
an upper plate with permanent magnets attached on a surface thereof opposite to the lower plate and having rails formed therein having a shape complementary to the rails of the lower plate, said upper plate being engaged with the lower plate via the rails.

2. The sliding hinge apparatus as claimed in claim 1, wherein the rails that form an interconnection structure between the lower plate and the upper plate are formed with rectangular grooves at one of the lower and upper plates and rectangular protrusions at corresponding portions of the other plate.

3. The sliding hinge apparatus as claimed in claim 1, wherein the permanent magnet on the lower plate comprises a plurality of permanent magnets attached on the surface of the lower plate at regular intervals, and the permanent magnet on the upper plate comprises a plurality of permanent magnets attached on the surface of the upper plate at a regular intervals.

4. The sliding hinge apparatus as claimed in claim 3, wherein four unit magnets corresponding to the permanent magnets are formed as a single permanent magnet assembly at a regular intervals, and two unit magnets corresponding to the permanent magnets are formed as another permanent magnet assembly.

5. The sliding hinge apparatus as claimed in claim 2, wherein the permanent magnet on the lower plate comprises a plurality of permanent magnets attached on the surface of the lower plate at regular intervals, and the permanent magnet on the upper plate comprises a plurality of permanent magnets attached on the surface of the upper plate at regular intervals.

6. The sliding hinge apparatus as claimed in claim 5, wherein four unit magnets corresponding to the permanent magnets are formed as a single permanent magnet assembly at regular intervals, and two unit magnets corresponding to the permanent magnets are formed as another permanent magnet assembly.
